(19) United States
(12) Patent Application Publication
(10) Pub. No.: US 2004/0146714 A1
(43) Pub. Date: Jul. 29, 2004

(54) Laminated molded article

(75) Inventors: Robert P. McCollum, Transfer, PA (US); Shiraz Sidi, Hermitage, PA (US); Jeffrey J. O'Hara, Sharon, PA (US); Richard Eugene Clark, Osceola, IN (US)

Correspondence Address: MERCHANT & GOULD PC, P.O. BOX 2903, MINNEAPOLIS, MN, 55402-0903, US

(73) Assignee: VEC Industries, L.L.C.

(21) Appl. No.: 10/678,931

(22) Filed: Oct. 3, 2003

Related U.S. Application Data
(63) Continuation-in-part of application No. 10/351,254, filed on Jan. 24, 2003.

(51) Int. Cl. B32B 5/14

(52) U.S. Cl. 428/411.1; 428/500; 428/171

(57) ABSTRACT

A composite construction, such as a boat hull, comprising a thermoplastic layer and a fiberglass reinforcement composite. The thermoplastic layer comprises an acrylic film having a thickness of 0.5 to 1.5 mm and an ABS layer having a thickness of 0.5 to 15 mm. The reinforcement may also include cured polyurethane foam stringers or logs to provide additional rigidity and strength to the construction.

### CROSS REFERENCE TO RELATED APPLICATIONS

This application is a continuation-in-part of patent application U.S. Ser. No. 10/351,254 filed Jan. 24, 2003.

### BACKGROUND OF THE INVENTION

The invention relates to a structural laminate. The invention further relates to a shaped and layered reinforced composite construction. The construction is in the form of a laminated material having improved physical properties affecting the structural integrity and cosmetic appearance of the construction. Improved attributes include weatherability, strength and resistance to cracking, marring and non-aqueous solvents.

Composite structures comprising a fibrous reinforcement material impregnated with a curled, thermo-set resin are known for manufacturing useful, non-metal articles for consumer and industrial purposes. Fiber reinforced composite articles are known for their strength and durability. In addition to having desirable structural characteristics, the articles may have a decorative or visually attractive surface. The decorative surface may be a visually exposed layer formed on the exterior, the interior, or on a potion thereof, or the entire surface of a useful article, to provide a smooth, attractive appearance. The visually exposed layer may be polished, shiny or matte, transparent, white or colored. Materials selected for the decorative surface of the composite require a combination of desirable properties including outdoor weatherability, impact resistance, attractive cosmetic qualities and ease of processing.

Conventional methods for making fiber reinforced composite structures involve manually shaping the reinforcing fiber to a mold surface and then impregnating the fiber with an appropriate curable, thermosetting resin. Typically, a gel coat of clear or pigmented thermosetting resin is applied to the surface of the mold before forming a final laminate structure. The gel coat results in a cosmetically attractive exterior surface for the finished article and protects the fiber composite from attack by ultra violet radiation. However, layers made from gel coat materials can under adverse circumstances, develop crazing, cracks and color fading over time. Cracks can range from surface or cosmetic hairline cracks to cracks that extend from the surface of the gel coat into the laminate resulting in potential structural defects. Even hairline cracks need to be repaired to prevent greater structural damage from developing. Repairs can be expensive and the original color of the gel coat is virtually impossible to match.

Gel coats are typically applied to the mold surface in liquid form. The thickened liquid gel coat material is placed on the mold surface in a layer about 0.3 mm to about 0.8 mm thick. The gel coat material contains volatile organic components (VOCs) such as styrene monomer that is released to the ambient environment. Many of these volatile components are classified as hazardous air pollutants that are harmful to human health and the environment. Stricter government regulation continually lowers emission standards. Further, VOCs are often flammable resulting in a fire hazard. Elaborate precautions and expensive equipment is required to minimize the release of and exposure to these volatile substances.

An alternative to a thermosetting resin gel coat is a thermoplastic sheet on the exterior surface of the composite. Thermoplastic sheets have better weatherability and more flexibility than thermosetting plastics and have less tendency to form cracks. The sheet may be shaped by thermoforming methods and then reinforced with fiberglass composite backing. Chapman et al., U.S. Pat. No. 5,875,732 disclose a boat hull construction comprising ultra high molecular weight (UMHW) polyethylene having KEVLAR® and fiberglass-resin reinforcement. The thermoplastic UHMW polyethylene hull is shaped in a thermoforming step and the reinforcement applied to the inner surface of the hull using a vacuum bag molding technique. Vacuum bag molding processes involve conventional lay-up of resin and filler materials on an open mold followed by covering the lay-up materials with a plastic layer that enables a vacuum to be drawn to force the plastic against the reinforcement materials. Russell, U.S. Pat. No. 4,178,406 discloses a method for making a fiberglass-reinforced article wherein a preformed thermoplastic film is placed in a holding fixture, a reinforcing fibrous material and curable thermosetting resin layer are applied to the film and finally, a second preformed thermoplastic film is applied to the reinforcing layer. The composite is then subjected, in a thermoforming process, to a vacuum to form the shaped article. The film is in the form of a sheet having an average thickness of 40 mils (about 1 mm). Such thin materials can be difficult to handle and are easily wrinkled resulting in an unsightly appearance and uneven bonding between the film and the reinforcing layer.

Rigid, thermo formable panels comprising an acrylic film laminated to a thermo formable substrate provide improved handling properties. Representative panels are described in Rutledge, U.S. Pat. No. 4,221,836, Goldsworthy, U.S. Pat. No. 4,498,941 and Hicks et al., U.S. Pat. No. 5,069,851. The rigid panels can be shaped by thermoforming methods well known in the art and reinforced with a composite thermosetting resin and fiberglass backing. Combining the fiberglass reinforced polyester resin with the individual thermoformed product is generally performed manually outside the thermoforming mold in a slow, labor-intensive process. Such a method results in undesirable emission of hazardous air pollutants during application.

Boat hulls, components of motor or recreational vehicles, tubs, tub surrounds and spas, due to their wear in normal use and/or exposure to sun, tend to loose their glossy appearance, develop a chalky surface and may develop “orange peel” micro-cracks that can ultimately result in structural failure of the composite construction.

For these and other reasons, there is a continuing need to improve the useful lifetime, aesthetic properties and structural integrity of shaped and layered reinforced, composite molded constructions.

### SUMMARY OF THE INVENTION

The invention provides a shaped and layered construction comprising a layer of a thermoplastic acrylic polymer having a thickness up to about 2.5 mm, or greater than about 1 mm to about 2.5 mm, a layer of a thermoplastic polymer having a thickness of 0.5 to 15 mm, and a third layer of fiber reinforcement composite. The range of thickness for the first and second thermoplastic layers may or may not overlap. For example, the thickness of the first layer may be up to about 2.5 mm and the thickness of the second layer from about 3.0 mm to about 15 mm. The construction may also include a member comprising rigid polyurethane foam. The polyurethane foam member functions to provide stiffening for the construction or floatation in the case of marine articles. The construction may have a second fiber reinforcement composite layer enclosing the rigid polyurethane foam reinforcement. The term “composite” refers generally to a combination of one or more materials differing in form or composition on a macro-scale. The constituents retain their identities in the sense that they do not dissolve or merge completely into one another, although they act in concert. Normally the components can be physically identified and exhibit an interface between one another.

The acrylic polymer layer provides a cosmetically attractive appearance to the structure and resists cracking and accidental marring. The acrylic polymer layer constitutes the surface of the construction that is normally viewable and is usually the exposed, exterior surface. The surface may have a flat, curved, concave or convex shape. Incorporating colored material, such as a pigment, into the acrylic polymer layer, may vary the appearance of the construction. Graphic arts methods may be used to incorporate a decorative design into or onto the construction. The construction is useful for automotive applications, marine articles such as boat hulls and hatches, outdoor recreational vehicles such as ATVs and snowmobiles and, in general, for any structure that is exposed to outdoor environmental conditions, direct sunlight and extreme temperature ranges.

The thermoplastic acrylic polymer layer and the thermoplastic layer may be a laminate in the form of a combined thermoplastic sheet. The thermoplastic sheet may be preformed by conventional thermoforming methods to a desired shape. Non-exclusive possible shapes include components of an auto body such as door, hood, trunk, grill, and tonneau panels, tub, tub surrounds, spas, a boat hull and boat components such as decking, hatches and seats, and components of recreational objects such as ATVs, power water craft, outboard motor cowling, water skis and surf boards. The thermoplastic sheet is shaped so that the acrylic polymer layer is the exterior or normally visible layer of the composite construction. The acrylic polymer layer provides a durable surface with an attractive appearance to exterior of the molded article while the thermoplastic layer provides strength and rigidity to the molded article. The thermoplastic may be ABS, ASA or ABS-acrylic alloy, for example. A thermoplastic alloy is simply a mixture of thermoplastics that results in a melt stable single-phase material because the polymers have some interaction that combines them together. The acrylic polymer may comprise polyacrylate ester, polymethylmethacrylate ester or thermoplastic chemical derivatives of these polymers. Likewise, the ABS-acrylic alloy may comprise one or more than one of a polyacrylate ester, a polymethylmethacrylate ester and their chemical derivatives.

The thermoplastic sheet may have more than two layers. For example, one or more layers of thermoplastic acrylic polymer, acrylic-styrene-acrylonitrile (ASA), or ABS-acrylic alloy may be laminated to the surface of the thermoplastic sheet that will become the interior surface of the molded article. The interior layer constitutes a surface of the construction to which fiber reinforcement composite is usually applied. The thermoplastic sheet would have a exterior layer of a thermoplastic acrylic polymer, a layer of thermoplastic polymer selected from ASA, ABS or ABS-acrylic alloy and an interior layer of acrylic polymer, ASA, or ABS-acrylic alloy. The interior layer of acrylic polymer, ASA, or ABS-acrylic alloy provides an improved bonding surface for the thermoset resin to form a stronger bond between the cured thermoset resin and the thermoplastic sheet.

The fiber reinforcement composite comprising fiber reinforcement and thermoset resin is applied to the interior surface of the molded thermoplastic sheet and cured. The fiber reinforcement composite provides strength and rigidity to the construction. The fiber reinforcement may be woven or non-woven synthetic or natural material. Suitable thermoset resins are well known to those skilled in the art and include generally resins capable of undergoing an irreversible, chemical cross linking reaction. The thermoset resin should be adhered to or form a strong adhesive bond with the mating surface of the thermoplastic sheet. The strength of the bond may be enhanced if the interior (bonding) surface of the thermoplastic sheet is acrylic or acrylic alloy.

The construction may further have a cured polyurethane foam reinforcement, having varied geometries, to provide additional rigidity to the construction. If the construction is a boat hull, the rigid polyurethane foam may be used to reinforce the transom, deck or seats, for example, as well as the hull. Polyurethane foam also provides buoyancy to marine articles. Certain rigid polyurethane foam reinforcement members are also known in the art as “stringers” or “logs” when used to reinforce a boat hull. The polyurethane foam reinforcement may be in the form of a pre-shaped, rigid foam article that is positioned on the fiber reinforcement layer. The shape of the log generally conforms to the shape of the thermoformed thermoplastic sheet. The conforming shape indexes the position of the log with respect to the shape of the thermoplastic sheet during injection of thermoset resin thereby reducing the likelihood of the log shifting its position after the mold is closed. The rigid foam article may be positioned on the fiber reinforcement layer prior to or after infusing the fiber reinforcement material with thermosetting resin. It is usually more convenient to position the rigid polyurethane foam reinforcement before infusing the thermosetting resin. The rigid polyurethane foam reinforcement may be enclosed with an additional fiber reinforcement composite layer. The additional composite layer helps to retain the rigid polyurethane foam reinforcement in place and further strengths the construction. The number and placement of the rigid polyurethane foam reinforcement articles is determined by the shape and size of the composite construction.

An appropriately sized thermoplastic sheet is shaped by thermoforming means to obtain a shape that conforms to the mold shape for forming the final composite structure. The thermoplastic sheet material can be warmed in order to ease formation of the structure or shape in the thermoforming step. The thermoforming mold can also be warmed or heated to an appropriate temperature to efficiently introduce the shape into the thermoplastic sheet. A temperature of the mold is carefully selected to match a temperature useful with the thermoplastic sheet. In some instances, the temperature used is greater than the softening point of the thermoplastic sheet. Generally, for thermoplastic sheets, the thermoforming step is conducted at a temperature greater than 150° F. typically from about 250° F. to about 350° F.

A closed molding apparatus such as multiple insert tooling technology available from RTM Composites, Fenton, MI or the apparatus described in McCollum et al., U.S. Pat. No. 6,143,215 may be adapted to form the composite construction. The apparatus of the '215 patent comprises opposed apart and closed male and female mold halves having complimentary molding surfaces. When the two mold halves are assembled with their respective molding surfaces in opposition to one another, a mold plenum is defined within which to fabricate the desired article. The thermoplastic sheet may be preformed to a desired shape substantially conforming to the shape of the mold surfaces, particularly the mold surface for receiving the acrylic side of the thermoplastic sheet. The thermoplastic sheet is formed so that the acrylic polymer layer is the exterior, or “show”, layer of the composite structure. The thermoplastic sheet and the mold surfaces have complimentary shapes so that the thermoplastic sheet can be positioned between the mold halves and allow the mold halves to be brought together to define the mold plenum with little or no modification or distortion of the mold surface or the thermoplastic shape. In order to prevent accidental marring of the acrylic surface by the mold surface, a soft liner may be placed between the acrylic surface and the mold surface. Liner material may have single or multiple layers. Examples of suitable soft liner materials include felt or a composite of plastic film laminated to sponge, thermoplastic foam or other resilient backing. Typically, the liner material is pattern cut to cover the mold membrane and is affixed to the surface of the membrane with adhesive. A soft liner also accommodates slight variations in the dimensions of the shaped thermoplastic sheet that may occur during the thermoforming process. For example, softening and hardening of a thermoplastic may result in some dimensional shrinkage. If the cooling rate of the thermoformed sheet varies, it may cause slight shrinkage of the sheet that cannot be easily controlled. Shrinkage adversely affects the ability of the thermoplastic sheet to conform closely to the shape of the mold membrane. A soft liner compensates for small differences in the dimensions of the thermoformed sheet and the mold membrane.

Fibrous reinforcement material is placed on the interior surface. If a polyurethane foam log is a component of the construction, it is positioned on the fiber reinforcement material and a second layer fiber reinforcement material is positioned to cover the log and overlap with the first layer of fiber reinforcement material. The opposed apart mold halves are brought together to form the mold plenum. Molding fluid is injected into the mold plenum to impregnate the fibrous reinforcement material. The mold plenum is a substantially closed system that prevents escape of volatile organic substances from the molding fluid to the atmosphere. The molding fluid is cured to form a rigid composite molded article. Substantially all of the thermosetting material undergoes a cross linking reaction and forms a solid reinforced composite structure leaving little volatile material.

The composite constructions of the invention can be made by open or closed molding methods. The process described above illustrates one closed molding method, but other closed molding methods known to those skilled in the art, such as vacuum bag or multiple insert tooling methods, are equally applicable.

Other details and advantages of the invention will become apparent from the following detailed description and the accompanying figures.

### BRIEF DESCRIPTION OF THE DRAWINGS

FIG. 1 is a boat hull having laminated features of the invention.

FIG. 2 is a cross section of a boat hull construction.

FIG. 3 is a partial profile of a boat hull construction.

FIG. 4 is a cross section of another embodiment of the invention.

FIG. 5 is a cross section of another embodiment of the invention.

FIG. 6 is a cross section of another embodiment of the invention.

FIG. 7 is a cross section of another embodiment of the invention.

### DETAILED DESCRIPTION OF THE INVENTION

The diverse applications for fiber reinforced composite articles includes structural and decorative parts of land vehicles such as automobiles, trucks, vans and buses, campers and trailers including, for example, truck beds and covers, tonneau covers and hoods, grill covers and body panels; building and construction articles and replacements parts including bathtubs, hot tubs, showers, shower pans and wall surrounds; recreational water craft including boat hulls, decks, hatch covers, masts, seating and consoles; recreational equipment such as golf cart chassis and bodies, canoes and kayaks; playground equipment such as water slides, surf boards, snow and water skis, sandboxes; and aircraft and aerospace components. In general, composite fiber reinforced structures are suitable replacements for metal in a broad variety of uses where strength and durability are necessary and an attractive or decorative appearance is desirable.

One composite construction of the invention is a boat hull. The designs of boat hulls vary in size and shape. A particular design may require rigid polyurethane foam reinforcement (stringers or logs) for strength, rigidity and floatation. The size, shape and number of logs for a particular hull design may differ from those described below. However, a person skilled in boat construction understands the structural criteria for a particular design. The invention is applicable to boat hulls suitable for construction from molded composite materials. Although a boat hull is used to exemplify a construction according to the invention, a person of ordinary skill recognizes that the full scope of the invention is not limited to a particular object or shape and includes a broad range of applications as illustrated above.

A boat hull according to the invention comprises a layer of acrylic polymer film having a thickness up to about 2.5 mm, often greater than 1 mm to 2.5 mm, and a layer comprising an ABS or ABS-acrylic alloy thermoplastic having a thickness of about 0.5 to about 15 mm. An additional layer comprising a thermoplastic acrylic polymer, ASA or ABS-acrylic alloy having a thickness up to about 2.5 mm may be included. A layer comprising fiber reinforcement composite is applied to the thermoplastic layer that is the interior layer of the finished construction. Rigid polyurethane foam reinforcement may be included in the construction next to the fiber reinforcement composite layer.

The construction of the invention uses a thermoplastic sheet having an acrylic polymer layer that provides a decorative or cosmetic appearance to the structure. The thermoplastic sheet has the benefit that it is easily included in a thermosetting structure, and avoids the problems inherent in a gel coat. Thermoplastic sheets useful in the invention include sheets having layer of acrylic film with a thickness up to about 2.5 mm and a layer of ABS or ABS-acrylic alloy with a thickness of about 0.5 mm to about 15 mm. The thermoplastic sheet may have an additional layer comprising a thermoplastic acrylic or ABS-acrylic alloy having a thickness up to about 2.5 mm.

Another useful thermoplastic sheet has a layer of thermoplastic acrylic, a layer of ASA and a layer of ABS. Thermoplastic sheets with more than three layers may be used, but are typically not economical. The thermoplastic sheet has a softening point of about 200° F. to about 400° F.

Suitable thermoplastic sheets may be formed by extrusion methods well known to those skilled in the art. A sheet having two layers or more layers is readily made using extrusion technology and is suitable for carrying out the invention. The sheets may be manufactured in the form of large rectangular sheets or in roll form that can be applied to molding processes suitable for forming constructions of the invention. The thermoplastic sheets must be easily handled and useful in thermoforming operations and in molding operations for forming a composite structure. An important aspect of the thermoplastic sheet is that it can be placed into a thermal forming mold that can achieve the general overall shape of the finishing mold. The thermoformed shape preferably has few or no bubbles, folds, sags, or other distortion of the smooth surface of the exterior acrylic polymer layer. Such surface flaws are to be avoided when forming the final article to provide a smooth uniform surface that, to the eye, has a uniform color density.

The thermoplastic sheet may be in the form of cut-sheet stock, roll-fed stock or directly extruded to the thermoforming mold. The thickness of the thermoplastic sheet may range from about 0.5 mm to about 15 mm. Roll-fed stock or direct extrusion thermoforming is generally limited to a sheet thickness less than about 3 mm. One skilled in the art will select sheet thickness based upon finished part requirements. Exemplary two layer thermoplastic materials include sheets having an ABS layer and a layer comprising a polyacrylate, polymethacrylate, or an acrylate/methacrylate copolymer and may include thermoplastic elastomers and elastomer blends. Further, the ABS layer may be alloyed with a polyacrylate, polymethacrylate, or an acrylate/methacrylate copolymer. Exemplary materials include an acrylic/ABS laminate sheet sold under the trade name ALTAIR PLUS and QUARITE PLUS both commercially available from Aristech Acrylics LLC, Florence Ky., LUSTRAN ABS 752 commercially available from Bayer Polymers, Pittsburg, Pa. and WEATHER PRO commercially available from Spartech Corp., Clayton, Mo. The acrylic portion of the laminate provides a cosmetically attractive exterior surface. Sheet materials are supplied in various grades and a person skilled in the art understands how to select a grade appropriate to achieve the desired characteristics of the finished construction. Sheet materials may be custom made by plastic extrusion methods to provide any number of layers and combination of thermoplastic materials for a particular appearance, structure, strength or molding process.

The construction also comprises fiber reinforcement or a filament reinforcement composite layer. Fiber reinforcement typically comprises a woven or non-woven sheet made up of fiber portions or filament materials. The woven or non-woven material can be formed from the fibers or can be impregnated or combined with other coatings or resins in the woven or non-woven sheet. A variety of natural or synthetic fibers can be used in the reinforcement layer. Natural fibers can include cotton, flax, jute, knaff and other fibers derived from natural sources known to one of ordinary skill in the art. Similarly, synthetic fibers can include polyolefin fibers, polyester fibers, polyamide fibers, and other such thermoplastic or thermosetting fiber materials. Inorganic fibers can include glass fiber reinforcement materials, carbon fiber reinforcement materials, or other specialty fibers such as boron fibers, etc.

The fiber reinforcement is infused with a molding fluid that is subsequently cured to strengthen the thermoplastic shape. Suitable molding fluids include unsaturated thermoset resins well known to those skilled in the art and include polyester, vinyl esters, acrylic polymers, polyepoxides, aminoplasts, alkyd resins, polyamides, polyolefins, polyurethanes, vinyl polymers and phenolic resins and mixtures thereof capable of undergoing an irreversible, chemical crosslinking reaction. Non-limiting examples of useful polyester materials include RD-847 A polyester resin commercially available from Borden Chemicals of Columbus Ohio, STYPOL polyester resins commercially available from Cook Composites and Polymers of Port Washington Wisc., POLYLITE polyester resins with styrene commercially available from Reichold Inc. of Durham, N.C. and NEOXIL polyesters commercially available from DSM B.V. of Como, Italy. The strength of the adhesive bond between the thermoplastic surface and the cured unsaturated thermoset resin may vary with different combinations of thermoplastic and resin. A person skilled in making reinforced composite structures understands how to select materials to optimize bond strength for a particular structure. Various additives may be incorporated into the resin including curing catalysts, viscosity modifying agents, mold release agents, fillers, pigments, opacifiers and the like. Viscosity modifying agents may include Group II metal oxides or hydroxides and crystalline, hydrogen saturated polyesters.

Useful resin includes the following formulations:

| | Parts by weight per each 100 |
|---|---|
| Component | parts of resin |
| Unsaturated polyester resin | 100 |
| Unsaturated vinyl resin | 0-100 |
| Styrene | 0-100 |
| Divalent metal; preferably a Cobalt mixed | 0.1-10 |
| carboxylate (6% in mineral spirits) | |
| Toludine compound | 0.1-10 |
| Acetyl acetamide compound | 0.1-10 |
| Mixed silicone wetting agent/deaerator | 0.1-10 |
| Vegetable Oil | 0.1-10 |
| Plastic microspheres | 0.1-10 |
| Inorganic filler, (CaCO₃, Al₂O₃ hydrate) | 5-30 |
| Pigment (Black) | 0.1-10 |
| Pigment (White) | 0.1-10 |
| Alkyl catechol compound | 0.001-0.1 |

The construction may further comprise rigid polyurethane foam reinforcement, often referred to as “logs” or “stringers”. Stringers are used to provide structural reinforcement and floatation for composite boat hulls. Stringers may be of any shape and dimension suitable to the design of the boat hull and are formed and cured by conventional methods for shaping polyurethane foam. Typically, the structural foam is 10 a two-part, self-expanding, self-curing foam that has expanded to fill the mold prior to cure. Major components of polyurethane are a disocyanate and an active hydrogen compound such as a polyol or polyamine. An isocyanate and active hydrogen functional group combine to form urethane bonds. Isocyanate compounds for forming polyurethane foam are commercially available in various grades from BASF Corp., Bayer Group and PPG Industries. Blowing agents for foam formation include “hydrogenated chlorofluorocarbons” (HCFC), water and/or CO₂. Suitable polyol compounds vary greatly in chemical structure to provide a broad range of physical properties. Typical polyol compounds include polyether polyols, polyvalent alcohols, bisphenol compounds, alkanol amines, polyester polyols, and so forth. Treatises, such as Rigid Urethane Foam Processing from Technomic, Pub. Co., or Urethane Foams: Technology and Application from Noyes Data Corp., are available that describe criteria for selecting components for forming polyurethane foam. Persons skilled in making polyurethane foam understand how to compound polyurethane to obtain desired properties.

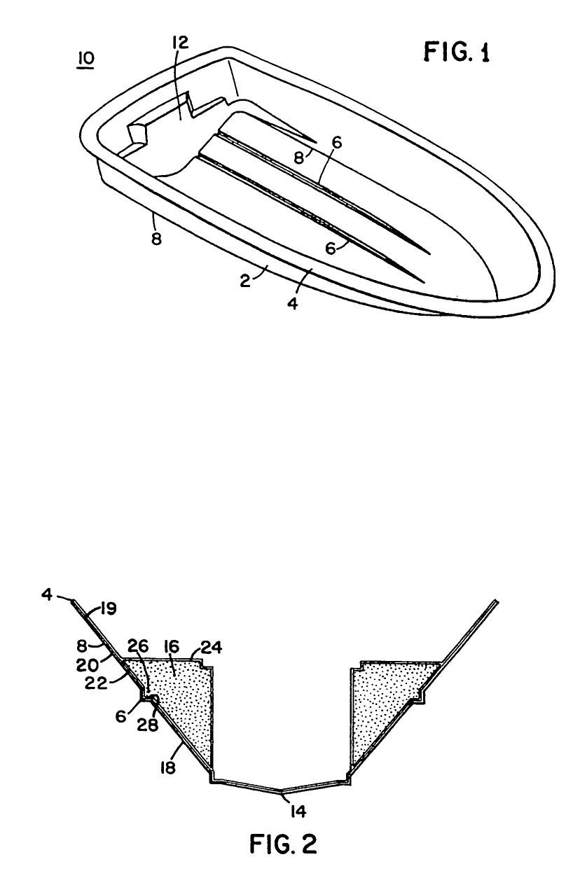

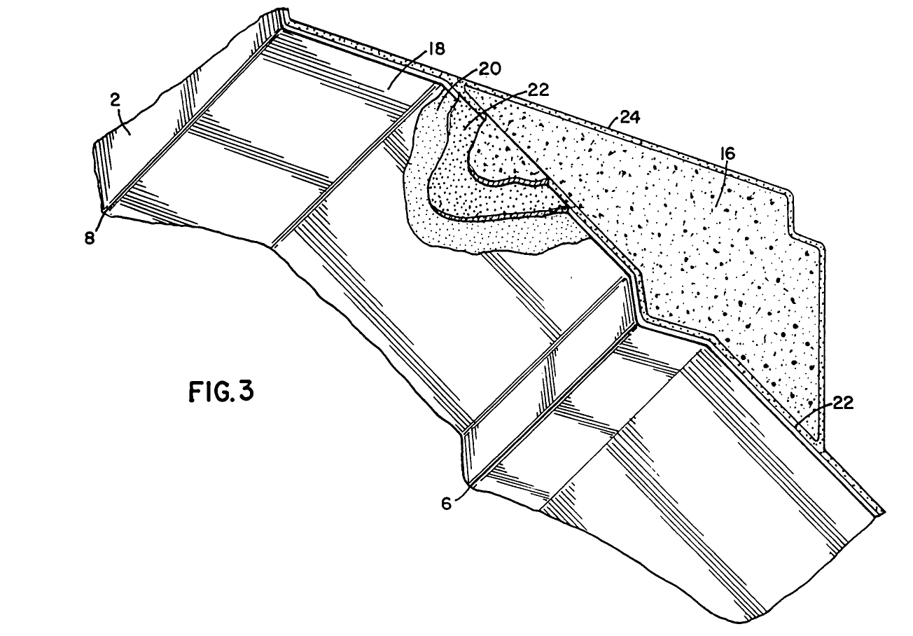

A composite construction according to the invention is describer with reference to FIGS. 1-3. FIG. 1 is a representation of a boat hull 10 having sides 2, a flange 4, strakes 6, chine 8 and a transom 12. The flange 4 may function as a gunwale or attachment surface for a deck, hull liner or other components of the construction. The side walls 2 are a substantially planar surface and may form an angle with the chine 8 of about 85° to 105°. The transom 12 may have apertures (not shown) for installing mechanical components such as a bilge pump or a stem drive. FIG. 2 shows the hull 10 in cross section and as substantially symmetrical with respect to the keel 14. The hull 10 includes side walls 2 forming an angle with a bottom surface 21 comprising an exterior thermoplastic acrylic polymer surface layer 18, a thermoplastic layer 20 having an interior surface 19, a fiber reinforcement composite layer 22 contiguous with the interior surface 19 and an optional rigid polyurethane foam stringer 16. The stringer 16 is enclosed with a second fiber reinforcement composite layer 24 to retain the stringer 16 in the desired position during the molding process. The stringer 16 may have a shape that conforms to the shape of the thermoplastic layer. The stringer 16 shown in FIG. 2 has a protrusion 26 that conforms to the depression 28 on the interior of the hull 10 formed by the strake 6. The protrusion 26 engages the depression 28 to assist retaining the stringer 16 in place during the molding process. The bottom surface 21 may be flat or curved. FIG. 3 is an enlargement of a portion of FIG. 2 showing the composite construction in greater detail.

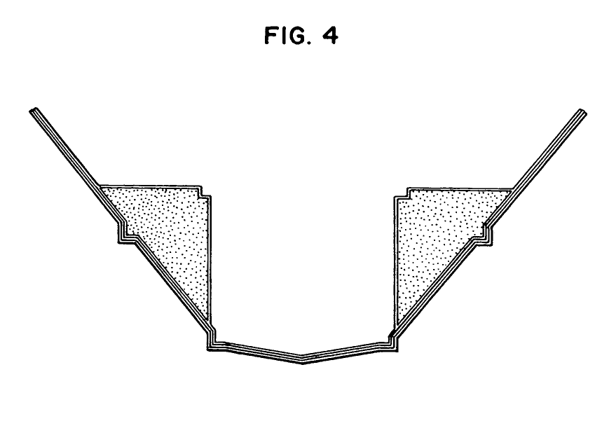

FIG. 4 shows in cross section of another embodiment of a hull construction having an additional interior layer 30 of thermoplastic material comprising an acrylic polymer, ASA or ABS/acrylic alloy contiguous with a the fiber reinforcement layer 32. The construction of FIG. 4 comprises an exterior acrylic polymer layer 18, an adjacent thermoplastic layer 20, a thermoplastic interior layer 30 contiguous with the thermoplastic layer 20 and a fiber reinforcement layer 32 contiguous with the interior layer 30. The interior layer 30 provides a bonding surface 34 for the fiber reinforcement layer 32. The construction may include a rigid polyurethane foam stringer 16. The stringer 16 is enclosed within a fiber reinforcement composite layer 24 to retain the stringer 16 in the desired position.

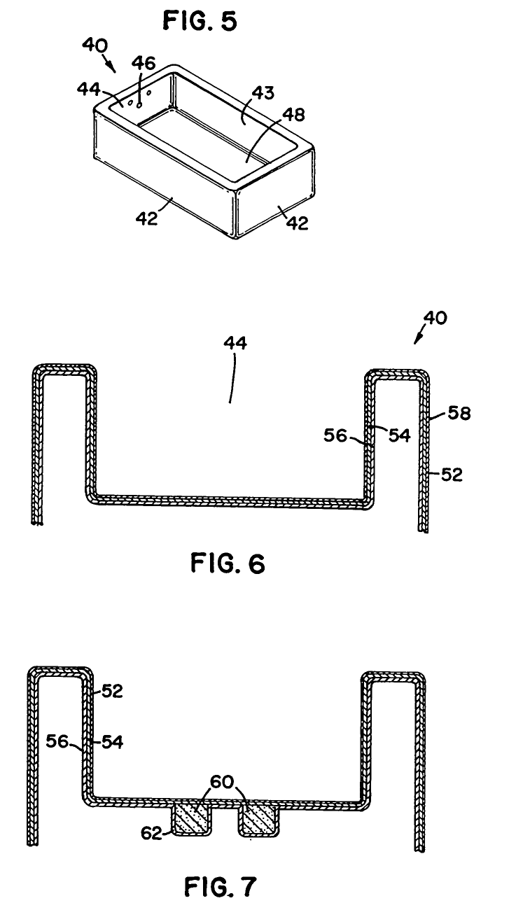

Another embodiment is described with reference to FIGS. 5-7. FIG. 5 is a representation of a tub 40 having exterior sides 42, interior sides 43, a bottom 48 adjacent the interior sides 43, a concave interior 44 and apertures 46 at one end for plumbing connections. FIG. 6 shows the tub 40 in cross section. The tub 40 includes an exterior thermoplastic acrylic polymer layer 52, a thermoplastic layer 54 laminated to the acrylic polymer layer 52, and a fiber reinforcement composite layer 56 contiguous with the thermoplastic layer 54. The acrylic polymer layer 52 has a cosmetically attractive surface 58 that is wholly or partly viewable depending on the installation of the tub 40. The tub 40 illustrates a construction having both concave and convex viewable surfaces. FIG. 7 shows the tub 40 in cross section with optional rigid polyurethane foam supports 60. The shape and position of the rigid polyurethane supports may vary with tub design as necessary to provide the desired strength and rigidity to the tub. The rigid polyurethane supports 60 are enclosed with a fiber reinforcement composite layer 62 to retain the support 60 in position during the molding process.

While certain embodiments of the invention have been disclosed and described herein, it should be appreciated that the invention is susceptible of modification without departing from the spirit of the invention or the scope of the following claims.

We claim:

1. A structure comprising a shaped and layered construction, the structure comprising:
(a) an acrylic polymer layer having a thickness up to about 2.5 mm;
(b) a thermoplastic layer having a thickness of about 0.5 mm to about 15 mm; and
(c) a third layer comprising a fiber reinforced composite.

2. A structure according to claim 1 wherein the acrylic polymer layer is an exposed exterior layer of the construction.

3. A structure according to claim 2 wherein the acrylic layer is adjacent the thermoplastic layer.

4. A structure according to claim 2 wherein the third layer is adjacent to the thermoplastic layer.

5. A structure according to claim 1 wherein the acrylic polymer layer is an exposed decorative exterior layer of the construction.

6. A structure according to claim 1 wherein the acrylic polymer layer is about 0.4 mm to about 1 mm and the thermoplastic layer is about 1.5 mm to about 15 mm.

7. A structure according to claim 2 wherein the layer of acrylic polymer and the thermoplastic layer comprise a laminate.

8. A structure according to claim 1 wherein the thermoplastic layer is selected from the group consisting of ABS, ASA or ABS-acrylic alloy.

9. A structure according to claim 7 wherein the laminate is a thermoplastic sheet.

10. A structure according to claim 1 wherein the structure is in the shape of a bathroom tub, tub surround or spa.

11. A structure according to claim 1 wherein the construction is a component of a motor vehicle.

12. A structure according to claim 11 wherein the construction is a component of a motor vehicle door, hood, trunk lid or tonneau.

13. A structure according to claim 1 wherein the construction is a component of a boat.

14. A structure according to claim 1 wherein the construction is a component of a recreation vehicle.

15. A structure according to claim 1 wherein the construction is a component of a recreational equipment.

16. A structure according to claim 15 wherein the construction is a component of a canoe, kayak, water slide, water skis, golf cart or playground equipment.

17. A structure according to claim 1 wherein the construction is a component of an aircraft or aerospace device.

18. A structure according to claim 1 further comprising rigid polyurethane foam reinforcement.

19. A construction according to claim 1 wherein the fiber reinforced composite comprises a cured thermoset resin reinforced composite.

20. A construction according to claim 19 wherein the thermoset resin comprises a cured unsaturated polyester resin.

21. A construction according to claim 19 wherein the composite is reinforced with glass fiber

22. A structure according to claim 18 further comprising a fiber reinforcement composite layer enclosing the rigid polyurethane foam reinforcement.

23. A structure according to claim 1 further comprising a structure including a substantially planar surface adjacent to one angle of about 85 to 105°.

24. A structure according to claim 23 further comprising a curved surface adjacent to the angle or to the planar surface.

25. A structure according to claim 1 further comprising an installation aperture.

26. A structure according to claim 1 further comprising an attachment flange.

27. A structure comprising a shaped and layered construction, the structure comprising:
(a) an acrylic polymer layer having a thickness up to about 2.5 mm;
(b) a thermoplastic layer having a thickness of about 0.5 to about 15 mm;
(c) a third layer comprising an acrylic polymer, ASA or ABS-acrylic alloy; and
(d) a fiber reinforcement composite layer contiguous with the third layer.

28. A structure according to claim 27 wherein the acrylic polymer layer is an exposed exterior layer of the construction.

29. A structure according to claim 28 wherein the acrylic layer is adjacent the thermoplastic layer.

30. A structure according to claim 28 wherein the third layer is adjacent to the thermoplastic layer.

31. A structure according to claim 27 wherein the acrylic polymer layer is a decorative exterior layer of the construction.

32. A structure according to claim 27 wherein the acrylic polymer layer is about 0.4 mm to about 1 mm and the thermoplastic layer is about 1.5 mm to about 15 mm.

33. A structure according to claim 28 wherein the layer of acrylic polymer and the layer of thermoplastic comprise a laminate.

34. A structure according to claim 27 wherein the thermoplastic layer is selected from the group consisting of ABS, ASA or ABS-acrylic alloy.

35. A structure according to claim 33 wherein the laminate is a thermoplastic sheet.

36. A structure according to claim 27 wherein the structure is in the shape of a bathroom tub, tub surround or spa.

37. A structure according to claim 27 wherein the construction is a component of a motor vehicle.

38. A structure according to claim 37 wherein the construction is a component of a motor vehicle hood, door, trunk lid or tonneau.

39. A structure according to claim 27 wherein the construction is a component of a boat.

40. A structure according to claim 27 wherein the construction is a component of a recreation vehicle.

41. A structure according to claim 27 further comprising rigid polyurethane foam reinforcement.

42. A construction according to claim 27 wherein the fiber reinforced composite comprises a cured thermoset resin reinforced composite.

43. A construction according to claim 42 wherein the thermoset resin comprises a cured unsaturated polyester resin.

44. A construction according to claim 42 wherein the composite is reinforced with glass fiber

45. A structure according to claim 27 further comprising a fiber reinforcement composite layer enclosing the rigid polyurethane foam reinforcement.

46. A structure according to claim 27 further comprising a structure including a substantially planar surface adjacent to one angle of about 85 to 105°.

47. A structure according to claim 46 further comprising a curved surface adjacent to the angle or to the planar surface.

48. A structure according to claim 27 further comprising an installation aperture.

49. A structure according to claim 27 further comprising an attachment flange.

50. A structure comprising a shaped and layered construction, the structure comprising:
(a) an acrylic polymer layer having a thickness up to about 2.5 mm;
(b) a thermoplastic ABS or ABS-acrylic alloy layer having a thickness of about 0.5 mm to about 15 mm;
(c) a third layer comprising an acrylic polymer, ASA or ABS-acrylic polymer alloy;
(d) a fourth layer comprising a fiber reinforcement composite contiguous with the third layer; and
(e) a structural polymer foam reinforcement.

51. A structure according to claim 50 wherein the acrylic polymer layer is an exposed exterior layer of the construction.

52. A structure according to claim 51 wherein the acrylic layer is adjacent the thermoplastic layer.

53. A structure according to claim 51 wherein the third layer is adjacent to the thermoplastic layer.

54. A structure according to claim 50 wherein the acrylic polymer layer is an exposed decorative exterior layer of the construction.

55. A structure according to claim 50 wherein the acrylic polymer layer is about 0.4 mm to about 1 mm and the thermoplastic layer is about 1.5 mm to about 15 mm.

56. A structure according to claim 51 wherein the layer of acrylic polymer and the layer of thermoplastic comprise a laminate.

57. A structure according to claim 50 wherein the thermoplastic layer is selected from the group consisting of ABS, ASA or ABS-acrylic alloy.

58. A structure according to claim 56 wherein the laminate is a thermoplastic sheet.

59. A structure according to claim 50 wherein the structure is in the shape of a bathroom tub, tub surround or spa.

60. A structure according to claim 50 wherein the construction is a component of a motor vehicle.

61. A structure according to claim 60 wherein the construction is a component of a motor vehicle door, hood, trunk lid or tonneau.

62. A structure according to claim 50 wherein the construction is a component of a boat.

63. A structure according to claim 50 wherein the construction is a component of a recreation vehicle.

64. A structure according to claim 50 further comprising rigid polyurethane foam reinforcement.

65. A construction according to claim 50 wherein the fiber reinforced composite comprises a cured thermoset resin reinforced composite.

66. A construction according to claim 65 wherein the thermoset resin comprises a cured unsaturated polyester resin.

67. A construction according to claim 65 wherein the composite is reinforced with glass fiber

68. A structure according to claim 50 further comprising a fiber reinforcement composite layer enclosing the rigid polyurethane foam reinforcement.

69. A structure according to claim 50 further comprising a structure including a substantially planar surface adjacent to one angle of about 85 to 105°.

70. A structure according to claim 69 further comprising a curved surface adjacent to the angle or to planar surface.

71. A structure according to claim 50 further comprising an installation aperture.

72. A structure according to claim 50 further comprising an attachment flange.
